(19) United States
(12) Patent Application Publication
(10) Pub. No.: US 2007/0074436 A1
(43) Pub. Date: Apr. 5, 2007

(54) Device and method for distributing flyers

(76) Inventor: Jeffrey Steed, Pleasant View, UT (US)

Correspondence Address: ADVANTIA LAW GROUP, 9035 SOUTH 1300 EAST, SUITE 200, SANDY, UT, 84094, US

(21) Appl. No.: 11/242,798

(22) Filed: Oct. 3, 2005

(51) Int. Cl. G09F 3/18

(52) U.S. Cl. 40/661

(57) ABSTRACT

A flyer distribution device for holding and displaying flyers for distribution, which includes a transparent envelope including four corners, an opening, and a releasably couplable flap for closing the opening; a hole in each of the four corners; and a securing means attached to each of the holes. This invention also includes a method of distributing flyers which includes the steps of: placing flyers in an envelope, wherein the envelope includes: a transparent envelope including four corners, an opening, and a releasably couplable flap for closing the opening; a flexible roll flap attached to the envelope near the flap, and extending away from the opening; a hole in each of the four corners; and a securing means attached to each of the holes; securing the envelope to an openable and closable window of a vehicle, wherein the securing includes the steps of: attaching the securing means to the window; with the window open, placing the flexible roll flap in an opening created by opening the window; and closing the window over the flexible roll flap; and closing the releasably couplable flap.

### BACKGROUND OF THE INVENTION

1. Field of the Invention

The present invention relates to a device and method for distributing flyers, specifically devices configured to enclose flyers for distribution, and methods of distributing flyers using said devices.

2. Description of the Related Art

In U.S. Patent Application Publication No. 2003/0167670, Smith discloses a generally planar magnet contained in a traditional matchbook cover. The upper top portion of the cover folds over the front surface of the magnet and inserts between the lower portion of the magnet and the lower portion of the cover. The magnet includes a lower portion that is attached to the lower portion of the matchbook cover, and an upper portion that is detachable from the lower portion. The upper portion can include more than one detachable portion that can be individually removed. In other embodiments, the upper portion of the magnet is not detachable. The front surface of the magnet preferably bears one or more images, and is suitable for advertising or for displaying images.

U.S. Pat. No. 6,308,446 discloses a modular sign, which comprises a magnetic backing sheet, a chassis for supporting the backing sheet to provide a stable platform, and one or more sign inserts which may be coated on one side with a magnetically attractive coating so that the inserts can be held magnetically on the backing sheet. The magnetically attractive coating comprises a mixture of hydrogen-reduced iron of, preferably about 325 mesh, mixed with a clear enamel printing ink in approximately equal proportions.

U.S. Pat. No. 5,890,688 discloses a card mounting device for releasably mounting a business or calling card on the surface of a support includes a flexible sheet of paper having adhesive applied to one side thereof on one half of the sheet of paper and adhesive applied to the other side thereof on the other half of the sheet of paper.

Further, U.S. Pat. No. 6,347,471 discloses a transportable sign or message holder supports and displays replaceable signs or messages. A transparent front panel of polymeric material permits a sign or message to be viewed through the front panel. A rear panel, located behind the front panel, forms a cavity between the two panels and receives and supports a replaceable sign or message. The front and rear panels are attached at the bottom of the cavity and support the lower edge of a sign or message in the cavity. A pair of suction cups are mounted along the side edges for holding the two panels together and for detachably mounting the panels on a supporting structure.

Finally, U.S. Pat. No. 6,446,375 discloses a durable lightweight rigid transparent envelope that is slightly curved in shape from top to bottom and attaches to automobile windows via suction cups in order to hold and display a variety of double-sided thin flexible lightweight message sheets, which are highly color-contrasted, light-reflective and contain large font character size messages in order to facilitate visual communication between automobile operators, passengers and pedestrians at distances normally encountered on streets and highways. A selected message can be displayed in the envelope through the envelope's transparent front side when it is attached to the inside of an automobile window, or a selected message can be displayed through the envelope's transparent back side while the envelope is attached to the outside of an automobile window by the same means. Indentations at the top of the envelope provide for quick and easy removal of message sheets by grasping them with the tip of a thumb and finger of the hand Small notches at the top of the envelope provide for the attachment of elastic bands in order to hold the message sheets in place inside the envelope when laying flat while not in use or being stored.

What is needed is a flyer distribution device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available flyer distribution devices and methods. Accordingly, the present invention has been developed to provide a flyer distribution device for holding and displaying flyers for distribution, including: a transparent envelope including four corners, an opening, and a releasably couplable flap for closing the opening; a hole in each of the four corners; and a securing means attached to each of the holes.

The flyer distribution device may also include a flexible roll flap attached to the envelope near the flap, and extending away from the opening. The securing means may include suction cups. The securing means may include an adhesive pad.

In another embodiment, the a flyer distribution device for holding and displaying flyers for distribution, of the present invention includes only: a transparent envelope including four corners, an opening, and a releasably couplable flap for closing the opening; a hole in each of the four corners; a securing means attached to each of the holes; and a flexible roll flap attached to the envelope near the flap, and extending away from the opening.

The securing means may include a suction cups. The securing means may include an adhesive pad.

In yet another embodiment, this invention includes a method of distributing flyers, comprising the steps of: placing flyers in an envelope, wherein the envelope includes: a transparent envelope including four corners, an opening, and a releasably couplable flap for closing the opening; a flexible roll flap attached to the envelope near the flap, and extending away from the opening; a hole in each of the four corners; and a securing means attached to each of the holes; securing the envelope to an openable and closable window of a vehicle, wherein the securing includes the steps of: attaching the securing means to the window; with the window open, placing the flexible roll flap in an opening created by opening the window; and closing the window over the flexible roll flap; and closing the releasably couplable flap.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective view of the flyer distribution device according to one embodiment of the present invention;

FIG. 2 illustrates a plan view of the flyer distribution device in use on a vehicle according to one embodiment of the present invention; and

FIG. 3 illustrates; a perspective view of the flyer distribution device according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

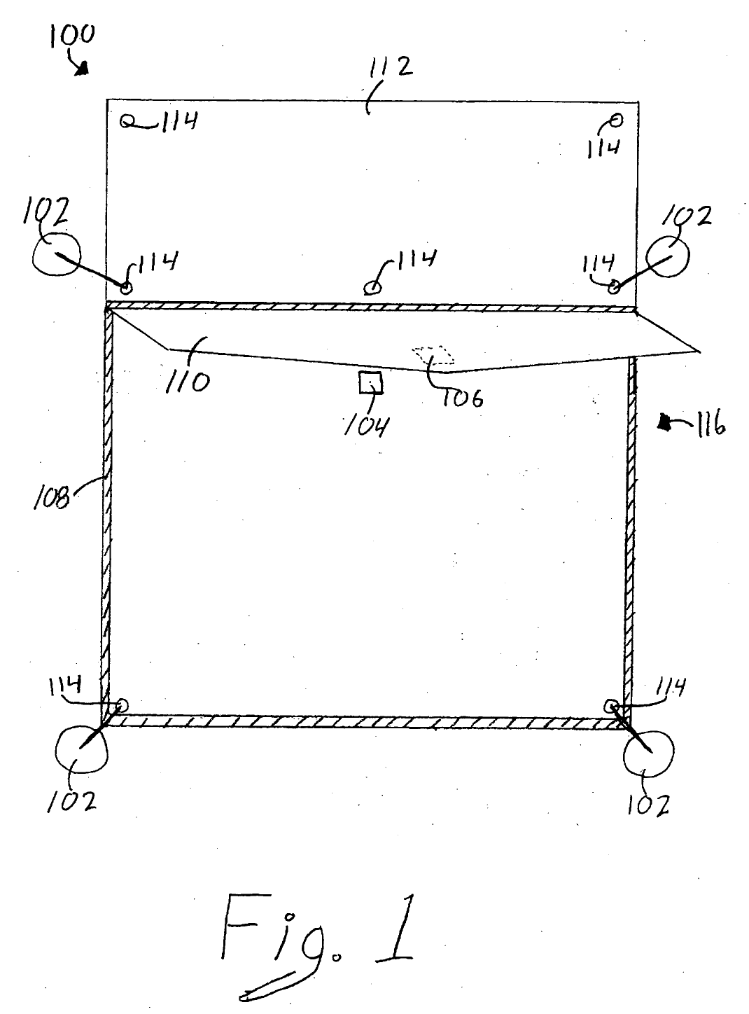

FIG. 1 illustrates a perspective view of a flyer distribution device according to the present invention. The flyer distribution device 100 includes an envelope 116. The envelope 116 may be constructed of a transparent material, and may be flexible. The envelope 116 may be constructed such that flyers may be placed inside of the envelope 116. In one embodiment, the envelope 116 has edges that are sealed 108. The edges 108 may be heat-sealed. The envelope 116 may include a closable flap 110. The closable flap 110 may fold over an opening in the envelope 116. The flap 110 may be releasably couplable to another part of the envelope 1116. In one embodiment, there is a releasably couplable area 104 on the body of the envelope 116, and a releasably couplable area 106 on the closable flap, positioned to correspond to the releasably couplable area 104 on the envelope 116 when the flap is closed.

The releasably couplable areas 104, 106 may be configured to allow the closable flap 110 to be releasably couplable to the envelope 116. The releasably couplable areas 104, 106 may by any that are known in the art. Some non-limiting examples of releasably couplable areas 104, 106 may include releasable adhesive, hook and loop fasteners, brads, hook and eye fasteners, buttons, snaps, and so forth. The preferred releasably couplable area 104, 106 includes a hook and loop fastener.

The flyer distribution device 100 may include holes 114. The device 100 may also include securing devices 102 attached to the holes 114. The securing devices 102 may be configured to secure the flyer distribution device 100 to a surface. In one embodiment, the securing devices 102 are configured to secure the flyer distribution device 100 to a vehicle. The securing devices 102 may be any known in the art. Some non-limiting examples of securing devices 102 include suction cups, adhesive pads, pads with releasable adhesive, magnets, hooks, screws, nails, and so forth.

In one embodiment, the flyer distribution device also includes a flexible roll flap 112. The flexible roll flap 110 may be attached to the envelope 116 near the closable flap 110. The flexible roll flap 112 may be attached to the envelope 116 and extend in a direction opposite of an opening in the envelope from the closable flap 110. The flexible roll flap 112 may be configured to be caught in a vehicle window to secure the flyer distribution device 100 to the vehicle window.

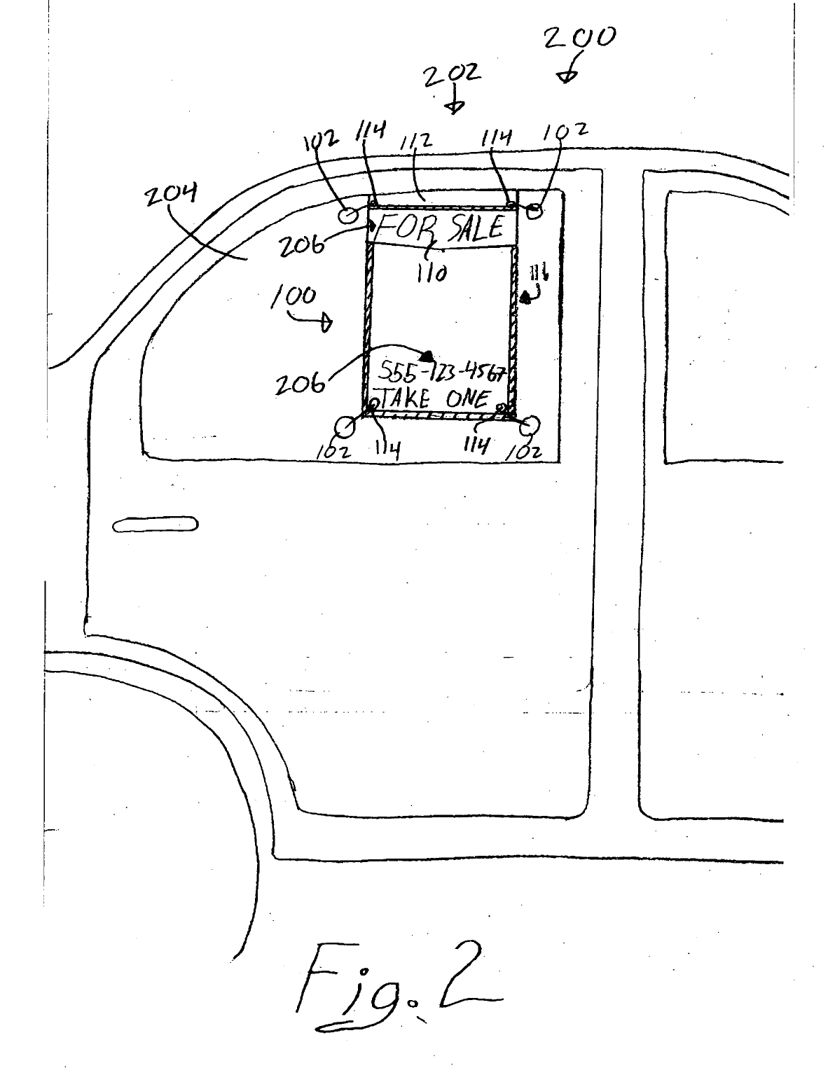

As can be seen in FIG. 2, illustrating the use 200 on a vehicle 202 of a flyer distribution device 100. In one embodiment, the flyer distribution device 100 is attached to a vehicle window 204. The window 204 may be capable of being opened and closed by moving or rolling up and down. According to this embodiment, the securing devices 102 releasably adhere to the window 204. The flexible roll flap 112 is caught between the window 204 and the vehicle.

FIG. 2 also illustrates that the flyer distribution device 100 may include words or figures 206. The words or figures 206 may be placed on the flyer distribution device 100 to attract attention to the flyers inside of the device 100, and hence entice viewers to take a flyer. The words or figures 206 may also convey information such as, but not limited to, telephone numbers, synopsis of the information on the fliers, and so forth.

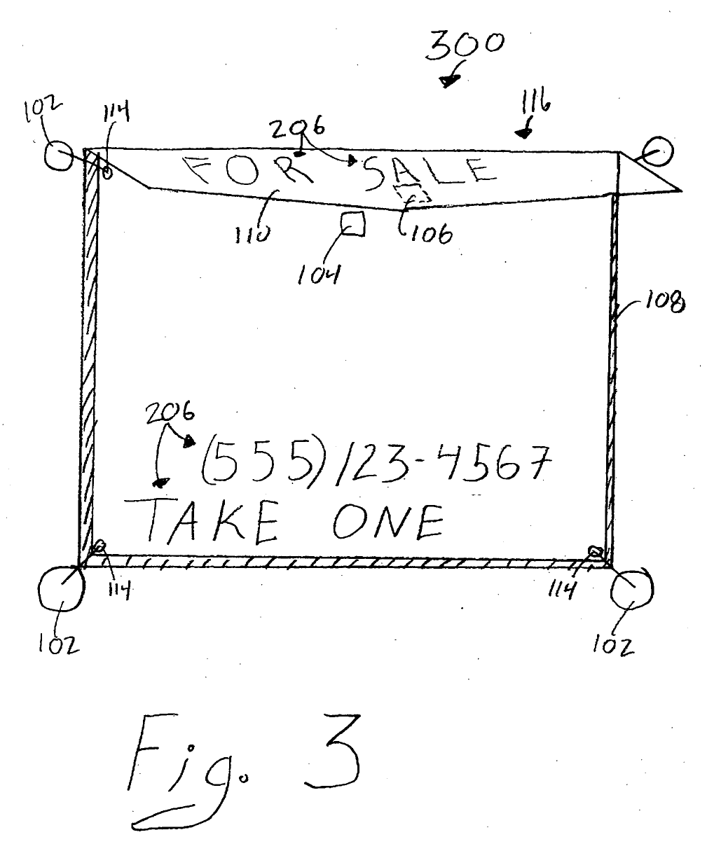

FIG. 3 illustrates a flyer distribution device 300 according to one embodiment of the present invention. In this embodiment the flyer distribution device does not include a flexible roll flap 112. The flexible roll flap 112 may be removed by the user of the device 100, 300. For example, the flexible roll flap 112 may be attached to the flyer distribution device 100 using a perforated or otherwise decouplable coupling. The user could then remove the flexible roll flap 112 if so desired. This embodiment includes the advantage of decreasing the complexity of the device. This embodiment also includes the advantage of being easier secured to a surface that is does not roll up or is not a closable window such as a vehicle window.

Also disclosed is a method of distributing flyers. The method includes placing flyers in a flyer distribution device 100, 300 according to any of the embodiments herein. The device 100 is then attached to a vehicle window 204 by attaching the securing devices 102 to the window 204. With the window 204 in a slightly open position, the flexible roll flap 112 may be placed between the window 204 and the vehicle 202 through the opening created when the window 204 is slightly opened. The flexible roll flap 112 is then caught between the window 204 and the vehicle 202 by closing the window 204 on the flexible roll flap 112. This method has the advantage of securing the flyer distribution device 100 to a further measure than would be available if the flyer distribution device 100, 300 did not have the flexible roll flap 112, or the flexible roll flap 112 was not caught between the window 204 and the vehicle 202.

Also disclosed is a flyer distribution device 300 including only an envelope 116 with an opening, a closable flap 110, releasably couplable areas 104, 106, attachment holes 114, and securing devices 102. The envelope 116 may include words or figures 206. The securing devices 102 may include any as described above. The releasably couplable areas 104, 106 may include any as described above. This embodiment includes the advantage of decreasing the complexity of the device. This embodiment also includes the advantage of being easier secured to a surface that is not a rollable or closable window such as a vehicle window.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Finally, it is envisioned that the components of the device may be constructed of a variety of materials, and not be limited to a clear vinyl plastic. Any material suitable for the purposes stated herein is within the scope of the present invention. Some non-limiting materials include polymers, glass, composite, metal, wood, paper, laminates, and so forth. Though a clear material is preferred, the present invention includes materials that are not clear. For example, the flyer distribution device of the present invention may be constructed of an opaque, fogged, or unclear material. Further, though the flyer distribution device is described as being flexible, except for the flexible roll flap, it may be constructed of a semi-flexible or inflexible material.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. A flyer distribution device for holding and displaying flyers for distribution, comprising:
a transparent envelope including four corners, an opening, and a closable flap for closing the opening;
a hole in each of the four corners;
a securing means attached to each of the holes; and
a flexible roll flap attached to the envelope near the closable flap, and extending away from the opening.

2. (canceled)

3. The flyer distribution device of claim 1, wherein the securing means comprises suction cups.

4. The flyer distribution device of claim 1, wherein the securing means includes an adhesive pad.

5. A flyer distribution device for holding and displaying flyers for distribution, consisting of:
a transparent envelope including four corners, an opening, and a closable flap for closing the opening;
a hole in each of the four corners;
a securing means attached to each of the holes; and
a flexible roll flap attached to the envelope near the closable flap, and extending away from the opening.

6. The flyer distribution device of claim 5, wherein the securing means comprises a suction cup.

7. The flyer distribution device of claim 5, wherein the securing means includes an adhesive pad.

8. A method of distributing flyers, comprising the steps of:
placing flyers in an envelope, wherein the envelope comprises:
a transparent envelope including four corners, an opening, and a closable flap for closing the opening;
a flexible roll flap attached to the envelope near the closable flap, and extending away from the opening;
a hole in each of the four corners; and
a securing means attached to each of the holes;
securing the envelope to an openable and closable window of a vehicle, wherein the securing includes the steps of:
attaching the securing means to the window;
with the window open, placing the flexible roll flap in an opening created by opening the window; and
closing the window over the flexible roll flap; and
closing the closable flap.
